(19) United States
(12) Patent Application Publication
(10) Pub. No.: US 2004/0010561 A1
(43) Pub. Date: Jan. 15, 2004

(54) System for remotely controlling home appliances and method for operating the same

(75) Inventors: Chang Ho Kim, Seoul (KR); Dae Sung Wang, Seoul (KR); Yeon Kyoung Lee, Kyungki-do (KR); Il Hoon Ji, Seoul (KR); Ki Tae Oh, Kyungki-do (KR); Sang Kyun Lee, Kyungki-do (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/385,533

(22) Filed: Mar. 12, 2003

(30) Foreign Application Priority Data
Jul. 11, 2002 (KR) 2002-40232

(51) Int. Cl. G06F 15/16

(52) U.S. Cl. 709/208

(57) ABSTRACT

Disclosed are a system for remotely controlling home appliances and a method for operating the same. The system for remotely controlling home appliances, includes: a wired and wireless Internet network; a home server for controlling and managing a home network connected to the home appliances; a central portal server for exchanging XML (extensible Markup Language) format data with the home server connected through the Internet network; and remote control equipment connected to the Internet network for remotely controlling the home appliances and forwarding a control command to the central portal server. The system and method can reduce a load of the home server and the central portal server and prevent the delay of data transmission, because an additional data format conversion process is not needed. The system and method simultaneously ensure the reliability and accuracy of the remote control system by preventing a malfunction of remote control due to an error of a command signal generated at the data format conversion process.

### RELATED APPLICATIONS

The present disclosure is related to subject matter contained in Korean Patent Application No. 2002-40232, filed on Jul. 11, 2002, which is expressly incorporated herein, by reference, in its entirety.

### BACKGROUND OF THE INVENTION

1. Field of the Invention

The present invention relates to a system for remotely controlling home appliances and a method for operating the same. More particularly, the present invention relates to a system and method for remotely controlling home appliances, wherein the system and method can reduce a load of a server and can rapidly and accurately transmit data by converting a format of data to be transmitted between a home server and a central portal server into an XML (extensible Markup Language) format so as to remotely control a home network system.

2. Description of the Related Art

Recently, the home-appliance network systems that connect a plurality of home appliances to a network installed inside a home or building have proliferated. In addition, the construction of a system for remotely controlling the home appliances, so that the home appliances can be remotely controlled from inside a home or outside a building, using a terminal connected to the Internet, has become popular.

A configuration and operation of the remote control system as described above will be described with reference to FIG. 1.

Remote control equipment 1 includes means capable of being connected to the Internet, i.e., a computer, a notebook computer, a mobile communication terminal, a PDA (Personal Digital Assistant), etc. The remote control equipment 1 can be connected to a wired and wireless Internet network and implement a GUI (Graphical User Interface) to display a Web page. A remote control operator controlling or operating the remote control equipment 1 can input a state information request and an operation control command for a plurality of home appliances A1 to A3 connected to a home network. The state information request and operation control command are input on a home page of a central portal server 100 connected through an Internet browser of the remote control equipment 1.

A command of an HTML (HyperText Markup Language) format displayed through the Internet browser is converted into that of a data format for a server process by a first data format conversion module 2 so that the command can be processed in an operating system (OS) of the central portal server 100. A signal of the command from the remote control equipment 1 converted into the data format for the server process is stored in a data storage module 4, and the command signal is processed in a remote control module 3 so that it can be transmitted through the Internet Network and a home server 200 of a home network connected to the home appliances to be controlled by the remote control module 3.

The command signal processed in the remote control module 3 is converted into a format for Internet transmission by a second data format conversion module 5 so that the command signal can be transmitted through the Internet network.

The command signal of the Internet transmission format is converted into that of a data format for a home server by a third data format conversion module 6 so that the home server 200 can process the received command signal of the Internet transmission format. Thus, the home server 200 performs a control operation in response to the command signal.

As described above, the conventional remote control system for the home appliances performs data format conversion processes many times to transmit data between the central portal server and the home server and hence the data transmission is delayed. Further, there is a disadvantage in that the accuracy of the command signal inputted from the remote control module cannot be ensured due to an error which may occur in the data format conversion processes. Hence, remote control of the home appliances cannot be accurately performed.

In particular, where the central portal server managing a plurality of home servers simultaneously performs format conversions for mass data to transmit the data to multiple home servers, there is another disadvantage in that data to be processed in the server is increased and then remote control cannot be appropriately performed.

### SUMMARY OF THE INVENTION

Therefore, the present invention has been made in view of the above problems, and it is an object of the present invention to provide a system for remotely controlling home appliances and a method for operating the same. The system and method are capable of rapidly and accurately processing, transmitting and receiving data, reducing a load of the central portal server, and providing the reliability of a remote control command and control execution by unifying formats of data transmitted and received between a central portal server and a home server in a single XML (eXtensible Markup Language) format, which can be processed in both the central portal server and the home server.

In accordance with one aspect of the present invention, the above and other objects can be accomplished by the provision of a system for remotely controlling home appliances. The system includes a wired and wireless Internet network; a home server for controlling and managing a home network connected to the home appliances; a central portal server for exchanging XML (extensible Markup Language) format data with the home server connected to the Internet network; and remote control equipment connected through the Internet network for remotely controlling the home appliances and forwarding a control command to the central portal server.

In accordance with another aspect of the present invention, there is provided a method for operating a remote control system for home appliances. The method includes inputting a command for controlling at least one home appliance connected to a home network through an Internet browser of remote control equipment; converting the command into an XML (extensible Markup Language) format; and transmitting a signal of the command to a home server of the home network and controlling the home appliance.

In accordance with yet another aspect of the present invention, there is provided a method for operating a remote control system for home appliances. The method includes inputting a command for controlling at least one home appliance connected to a home network through an Internet browser of remote control equipment; converting the command into an XML (extensible Markup Language) format; transmitting a signal of the command to a home server of the home network and controlling the home appliance; and converting the XML format into an HTML (HyperText Markup Language) format so that a control result signal based on the XML format is displayed on the Internet browser of the remote control equipment.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a configuration of a conventional remote control system for home appliances;

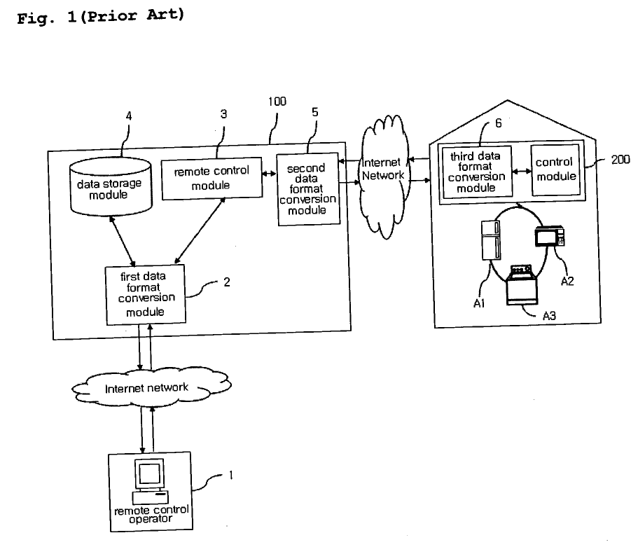

FIG. 2 is a view illustrating a configuration of a remote control system for home appliances in accordance with the present invention; and

FIG. 3 is a flow chart illustrating a method for operating the remote control system for the home appliances in accordance with the present invention.

### DESCRIPTION OF THE PREFERRED EMBODIMENTS

The preferred embodiments of the present invention will be described in detail below with reference to the annexed drawings.

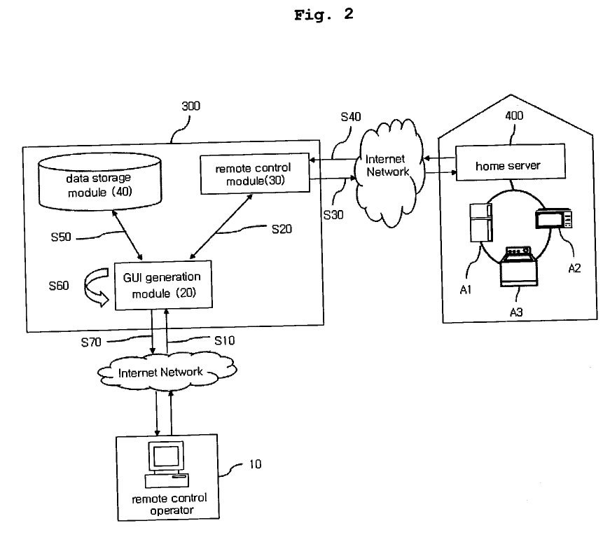

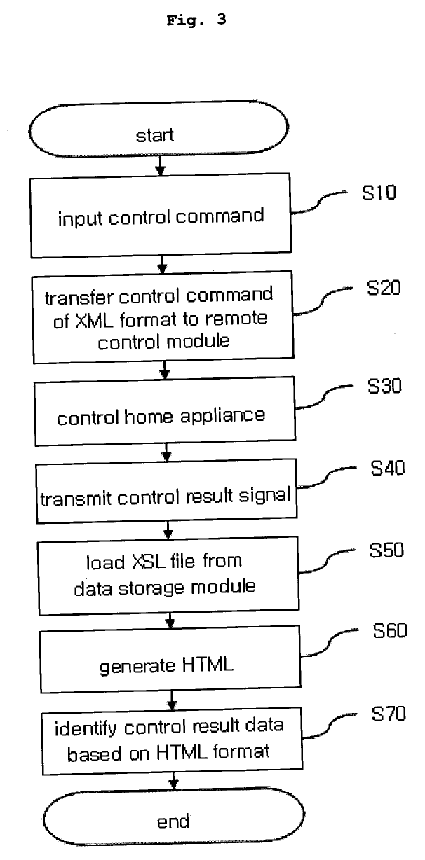

FIG. 2 is a view illustrating an exemplary configuration of a remote control system for home appliances in accordance with the present invention. FIG. 3 is a flow chart illustrating an exemplary method for operating the remote control system for the home appliances in accordance with the present invention.

XML (extensible Markup Language) was proposed as a language by W3C (World Wide Web Consortium) in 1996 and is a text format designed and standardized so that structured documents can be transmitted over the Web.

The XML is useful in transmitting data over the Internet and storing data. In particular, the XML is not limited to a specific user environment and provides a format readable in any user environment by providing new tags, which can be analyzed and recognized in a conventional application program. There is an advantage in that the XML can be easily converted into HTML (HyperText Markup Language) by defining new tags associated with an HTML format used at the time of displaying information through an Internet browser. In addition to the above-described advantage, other advantages of the XML are as described herein.

The XML defines a data declaration and provides a standardized method so that application programs of different sources can exchange data. Accordingly, on the basis of the XML, one application program can easily use data transmitted from the other application program and also different OS (Operating System)-based systems can exchange data. Further, since XML, which is a reliable standard proposed by the W3C, supports various solutions and application tools necessary for an interface with application programs to be implemented in the future, the XML's applicability will be expanded.

Thus, the present invention provides a system for remotely controlling home appliances and a method for operating the same to transmit data of an XML format between a central portal server and a home server on the basis of the XML's advantages.

The wired and wireless Internet network is a conventional Internet network using a wired and/or a wireless telephone network. Remote control equipment is a device equipped with a modem capable of being connected to a GUI (Graphical User Interface) and the Internet network, e.g., a computer, a notebook computer, a mobile communication terminal, a PDA (Personal Digital Assistant), etc. An Internet browser embedded in the remote control equipment can be connected to the Internet, and a Web page provided by the central portal server 300 can be accessed. Accordingly, a remote control operator can input a command signal necessary for checking and controlling a state of a home appliance on the Web page provided by the central portal server 300, that communicates with the remote control equipment 10.

The home server 400 controls and manages a home network connected to home appliances A1 to A3 and can check and control states of the home appliances. Accordingly, a user can directly access the home server 400 and input a command necessary for controlling a home appliance. The user can also access the central portal server 300 through the Internet network, thereby indirectly controlling the home server 400. Through mutual data transmission and reception, a plurality of home servers 400 connected to the central portal server 300 are controlled and managed by the central portal server 300.

The central portal server 300 manages a plurality of home networks by transmitting and receiving data to and from the home servers 400 connected through the Internet network. The central portal server simultaneously provides and manages Web pages so that a control command can be inputted through the remote control equipment 10 that is capable of being connected to the Internet network.

The central portal server 300 includes a GUI generation module 20 for generating a GUI of the Internet browser to display a control command input and a control command process result on the Internet browser of the remote control equipment 10, a data storage module 40 for storing the command inputted through the GUI generation module 20, and a remote control module 30 for transmitting the command inputted through the GUI generation module 20 to the home server 400 that is connected to the home network through the Internet network.

The GUI generation module 20 performs a conversion between the HTML format and the XML format so that the Internet browser can display data and so that an XML format data can be transmitted between the remote control module 30 and the home server 400. The GUI generation module 20 displays the Web page by combining XSL (extensible Stylesheet Language) loaded from the data storage module 40 and XML and then generating HTML.

The XSL, which is language used for creating a style sheet indicating an exact position where data fields of the XML format are displayed on a Web page, has also been developed by W3C. If XSL is used, displayed document contents, letter style information and position information on the Web page, etc., are transmitted to the Internet browser.

That is, if the remote control operator inputs a control command on the Web page (based on the HTML format) that is managed by the central portal server 300 through the Internet browser of the remote control equipment 10, the central portal server 300 converts the control command into an XML format and then transfers the converted control command to the home server 400. The home server 400 controls a home appliance on the basis of the control command of the XML format. If the central portal server 300 receives a result (based on the XML format) of the control, the GUI generation module 20 converts the result into the HTML format, and displays the converted result on the Web page through the Internet browser of the remote control equipment 10.

Accordingly, after a command signal of the HTML format inputted on the Web page that is connected through the Internet browser of the remote control equipment 10 is converted in the XML format by the GUI generation module 20, XML format data is inputted into the remote control module 30 and a gateway of the central portal server 300 as XML format data and transmitted to the home server 400.

Further, the home server 400 sends an XML format-based response corresponding to a command signal process result and state information signal to the central portal server 300. The central portal server 300 does not need an additional process for a data format conversion. Hence, a load of the server is reduced. Thus, a faster data process and transmission can be accomplished and a malfunction of remote control due to an overload of the server can be prevented.

Also, since a table structure of data of an application program stored in the data storage module 40 can be copied and processed on the basis of the XML, the central portal server 300 does not have to perform a data format conversion and hence a load of the central portal server 300 is reduced.

An operation method of the remote control system for home appliances will be described with reference to FIG. 3.

A command necessary for controlling home appliances connected to the home network is inputted on a Web page displayed through the Internet browser of the remote control equipment at step S10. The inputted command, which is in conventional HTML format data, is transmitted to the central portal server 300 through the Internet network.

The control command, which is in conventional HTML format, and which is transferred to the GUI generation module of the central portal server 300, is converted into [that based on] an XML format by the GUI generation module and transferred to the remote control module at step S20.

The XML command signal is transmitted to the home server of the home network and a home appliance is controlled at step S30. The control of the home appliances by the home server includes, e.g. the control of ON/OFF, the identification of operation states, etc. associated with the home appliances. The home server transmits a control result signal to the central portal server at step S40.

The control result signal based on the XML format is converted into the HTML format to be displayed through the Internet browser of the remote control equipment. After loading the XSL from the data storage module at step S50, an HTML format is generated by combining the XSL and the XML at step S60. The HTML is generated in a state where a configuration of a display of a Web page based on the XSL and the XML data are independently variable.

The central portal server needs to use one common routine so that a control command is inputted and transmitted through a plurality of pieces of remote control equipment using various operation systems and data formats, and the control command process result can be displayed.

The central portal server can process the control command inputted from the remote control equipment based on other operating systems (including a standard Web browser, a palm pilot, a glinter etc.). Thus, the remote control system for home appliances of the present invention has compatibility with a broad range of remote control equipment.

The user can identify control result data based on the HTML format displayed on the Web page at step S70.

In accordance with the embodiments and the accompanying drawings of the present invention, the remote control system for home appliances and the method for operating the same in which XML format data is used are illustrated in connection with one piece of remote control equipment and one home server. However, the present invention is not limited to the above-described embodiments and the accompanying drawings, and a plurality of pieces of remote control equipment and home appliances can be connected.

As should be apparent from the above description, the present invention provides a remote control system for home appliances and a method for operating the same, the system and method being capable of reducing a load of a central portal server and the delay of data transmission by unifying formats of data transmitted and received between a central portal server and a home server in a single XML format and omitting a data format conversion step. The present invention simultaneously ensures the reliability and accuracy of the remote control system by preventing a malfunction of remote control due to an error of a command signal generated at the data format conversion process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for remotely controlling home appliances, comprising:
a home communications network that connects a plurality of home appliance;
a home server that controls and manages the home communications network;
a central portal server that exchanges XML (eXtensible Markup Language) format data with the home server through an Internet network; and
remote control equipment connected to the Internet network for remotely controlling the home appliances and forwarding a control command to the central portal server.

2. The system as set forth in claim 1, wherein the central portal server includes:
a GUI (Graphical User Interface) generation module for generating a GUI of an Internet browser so that the control command is inputted and a control command process result is identified on an Internet browser used in association with the remote control equipment;
a data storage module for storing the command inputted through the GUI generation module; and
a remote control module for transmitting the command inputted through the GUI generation module to the home server connected to the home network through the Internet network.

3. The system as set forth in claim 2, wherein the GUI generation module separates XSL (eXtensible Stylesheet Language) format data and XML format data from HTML (HyperText Markup Language) format data and transfers the XML format data to the remote control module.

4. The system as set forth in claim 2, wherein the GUI generation module combines XSL format data loaded from the data storage module with XML format data and generates HTML format data.

5. A method for operating a remote control system for home appliances, comprising:
inputting a command for controlling at least one home appliance connected to a home network through an Internet browser of remote control equipment;
converting the inputted command into an XML (eXtensible Markup Language) format; and
transmitting a signal of the converted command to a home server of the home network and controlling the home appliance.

6. A method for operating a remote control system for home appliances, comprising:
inputting, through an Internet browser of remote control equipment, a command for controlling at least one home appliance that is connected to a home network;
b) converting the inputted command into an XML (extensible Markup Language) format;
transmitting a signal of the converted command to a home server of the home network and controlling the home appliance; and
converting the XML format into an HTML (HyperText Markup Language) format so that a control result signal based on the XML format is displayed on the Internet browser of the remote control equipment.

7. The method as set forth in claim 6, wherein converting the XML format includes:
loading XSL format data from a data storage module; and
combining the loaded XSL format data with XML format data transferred from a remote control module and generating HTML format data.

8. A system for remotely controlling home appliances, comprising:
a central portal server that exchanges XML (extensible Markup Language) format data with a home server through an Internet network, the home server controlling and managing a home communications network that connects a plurality of home appliances; the central portal server receiving, through the Internet network, control commands from remote control equipment to remotely control the home appliances.

9. The system as set forth in claim 8, wherein the central portal server includes:
a GUI (Graphical User Interface) generation module for generating a GUI of an Internet browser used in association with the remote control equipment so that the control command is received and a control command process result is identified;
a data storage module for storing the received command; and
a remote control module for transmitting the command received through the GUI generation module to the home server.

10. The system as set forth in claim 9, wherein the GUI generation module separates XSL (eXtensible Stylesheet Language) format data and XML format data from HTML (HyperText Markup Language) format data and transfers the XML format data to the remote control module.

11. The system as set forth in claim 9, wherein the GUI generation module combines XSL format data loaded from the data storage module with XML format data and generates HTML format data.
